(19) United States
(12) Patent Application Publication
(10) Pub. No.: US 2009/0271536 A1
(43) Pub. Date: Oct. 29, 2009

(54) DESCRIPTOR INTEGRITY CHECKING IN A DMA CONTROLLER

(75) Inventor: Renaud Tiennot, Aix en Provence (FR)

Correspondence Address: SCHWEGMAN, LUNDBERG & WOESSNER / ATMEL, P.O. BOX 2938, MINNEAPOLIS, MN, 55402, US

(73) Assignee: ATMEL CORPORATION, San Jose, CA (US)

(21) Appl. No.: 12/108,667

(22) Filed: Apr. 24, 2008

(51) Int. Cl. G06F 13/28

(52) U.S. Cl. 710/28

(57) ABSTRACT

The present invention relates to a Direct Memory Access controller that, in an embodiment, executes I/O descriptors conditionally. A linked list item contains a checksum computed on the descriptor fields. When the linked list item is fetched, the checksum is computed on the descriptor. If both checksums are equal, the linked list item is considered valid and the descriptor is executed. At the end of a DMA I/O, the next descriptor in the linked list is fetched. When the checksum fails, the descriptor is corrupted and the channel is stopped and an error is reported to the operating system.

### FIELD OF THE INVENTION

The present invention generally relates to DMA Controllers and, more specifically, to providing descriptor integrity checking in a DMA Controller.

### BACKGROUND OF THE INVENTION

Direct memory access (DMA) is a feature of modern computers that allows certain hardware subsystems within the computer to access system memory for reading and/or writing independently of the central processing unit (CPU). Many hardware systems use DMA including disk drive controllers, graphics cards, network cards, and sound cards. Computers that have DMA channels can typically transfer data to and from devices with much less CPU overhead than computers without a DMA channel.

DMA is commonly used as it allows devices to transfer data without subjecting the CPU to a heavy overhead. Otherwise, the CPU would have to copy each piece of data from the source to the destination. This is typically slower than copying normal blocks of memory since access to I/O devices over a peripheral bus is generally slower than normal system RAM. During this time the CPU would be unavailable for other tasks involving CPU bus access, although it could continue doing any work which did not require bus access.

A DMA transfer essentially copies a block of memory from one device to another. While the CPU initiates the transfer, it does not execute it. For “third party” DMA, as is normally used with an ISA bus, the transfer is performed by a DMA controller which is typically part of the motherboard chipset. More advanced bus designs such as PCI typically use bus mastering DMA, where the device takes control of the bus and performs the transfer itself.

A typical usage of DMA is copying a block of memory from system RAM to or from a buffer on the device. Such an operation does not stall the processor, which as a result can be scheduled to perform other tasks. DMA is essential to high performance embedded systems. It is also essential in providing zero-copy implementations of peripheral device drivers as well as functionalities such as network packet routing, audio playback and streaming video.

In addition to hardware interaction, DMA can also be used to offload expensive memory operations, such as large copies or scatter-gather operations, from the CPU to a dedicated DMA engine. While normal memory copies are typically too small to be worthwhile offloading on today's desktop computers, they are frequently offloaded on embedded devices due to more limited resources.

### BRIEF SUMMARY OF THE INVENTION

The present invention relates to a Direct Memory Access controller that, in an embodiment, executes I/O descriptors conditionally. A linked list item contains a checksum computed on the descriptor fields. When the linked list item is fetched, the checksum is computed on the descriptor. If both checksums are equal, the linked list item is considered valid and the descriptor is executed. At the end of a DMA I/O, the next descriptor in the linked list is fetched. When the checksum fails, the descriptor is corrupted and the channel is stopped and an error is reported to the operating system.

### BRIEF DESCRIPTION OF THE DRAWINGS

FIG. 1 is a diagram showing an exemplary microcontroller architecture;

FIG. 2 is a diagram showing internal architecture of a DMA controller 120, in accordance with the microcontroller architecture shown in FIG. 1;

FIG. 3 is a diagram showing a DMA Channel with embedded transfer descriptor integrity checked, in accordance with one embodiment of the present invention;

FIG. 4 is a diagram showing an exemplary linked list of DMA descriptors, in accordance with one embodiment of the present invention;

FIG. 5 is a diagram showing a simple sequential parity check circuit, in accordance with one embodiment of the present invention; and

FIG. 6 is a Channel descriptor fetch flowchart, in accordance with one embodiment of the present invention.

### DETAILED DESCRIPTION OF THE INVENTION

More and more processing capabilities are required to execute a system level task without over exceeding power consumption. A DMA controller is a module that performs tasks like transferring data from a source peripheral or memory to a destination peripheral or memory. While performing these transfers, data from sources are typically locally stored in FIFO-like buffers located in the DMA controller. The DMA is a privileged place that is typically capable of accessing every peripheral and memory location. The use of a linked list of descriptors is, in an embodiment, a mechanism to program a DMA channel. When enabled, the DMA channel fetches a descriptor, and from that descriptor, reprograms its context registers. If the DMA I/O completes successfully, the channel fetches the next descriptor. The channel traverses the linked list of descriptors and performs DMA transfers until a “stop” marker is encountered. Channel descriptors are generally located in memory or in a memory mapped peripheral. A descriptor is corrupted if its content has been modified by anything other than the DMA controller itself since it was created. If a loaded descriptor is altered, the channel could potentially execute a wrong sequence of Read and Write operations destroying critical memory data or instructions. The following are some of the situations that could lead to descriptor corruption:
A software undefined operation modifies the descriptor.
CMOS Scaling down of IC feature size will likely impact memory reliability.
The error rate in SDRAM (DDR, DDR2) is not zero and a descriptor can potentially be read corrupted as a result of this.

The present invention relates to a Direct Memory Access controller, that in an embodiment, executes I/O descriptors conditionally. A linked list item contains a checksum computed on the descriptor fields. When the linked list item is fetched, the checksum is computed on the descriptor. If both checksums are equal, the linked list item is considered valid and the descriptor is executed. At the end of a DMA I/O, the next descriptor in the linked list is fetched. When the checksum fails, the descriptor is corrupted, the channel is stopped and an error is reported to the operating system. Wherever a DMA I/O descriptor resides (e.g. SDRAM, SRAM, memory mapped peripheral), its integrity is protected by this invention. When a random memory corruption occurs, a system fatal error can be avoided. Additionally, in early stages of software development, this simple mechanism provides a basic debug capability.

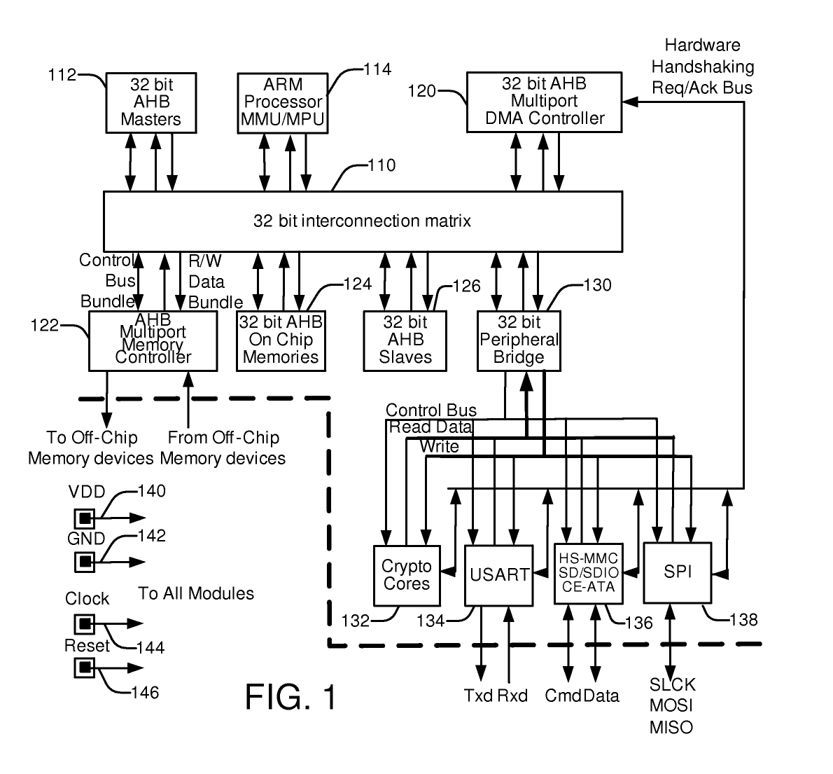

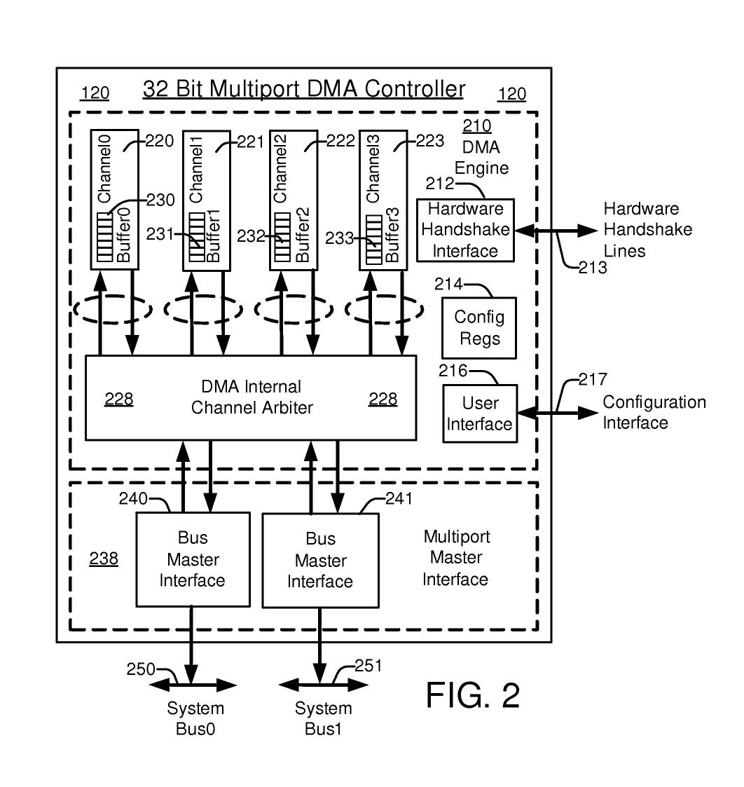

FIG. 1 is a diagram showing an exemplary microcontroller architecture based on which embodiments of the invention may be implemented. The architecture integrates at least one CPU core 114 (for example ARM926 or ARM11), a multiport DMA controller 120, an interconnection matrix 110, a set of slave communication peripherals 126, a set of master communication peripherals 112 embedding their own direct memory access controller, embedded memory, and SDR-DDR SDRAM memory controller 122. Also coupled to the interconnection matrix 110 is a peripheral bridge 130 which is coupled to multiple peripherals, in this example, a crypto core 132, USART 134, HS-MMC SD/SDIO CE-ATA 136, and SPI 138. The multiport DMA controller 120 is comprised of one or more bus interfaces, a configuration interface (located on the APB bus), an interconnection crossbar, a set of communication channels, a set of configuration registers and a hardware handshaking interface (See FIG. 2 on for more details). Bus master interface modules are used to communicate with the global interconnection network. In this embodiment, these interfaces comply with a communication protocol. The interconnection crossbar and channel arbiter provides access to the master bus interface. It is typically a point to point connection between a channel Read or Write data path and the bus master interface module. The set of communication channels comprise multiple buffers and a channel hardware controller. Configuration registers are used for both DMA global configuration and channel context register settings. The hardware handshaking interface allows the use of a dedicated protocol of communication between peripherals and the DMA channel.

FIG. 2 is a diagram showing internal architecture of a DMA controller 120, in accordance with the microcontroller architecture shown in FIG. 1. Shown in the DMA controller 120 is a DMA engine 210 with four DMA channels: Channel0 220, Channel1 221, Channel2 222, and Channel3 223. Each DMA channel 220, 221, 222, 223 has a corresponding communications buffer 230, 231, 232, 233. The DMA channels 220, 221, 222, 223 are coupled to and communicate bidirectionally with a DMA Internal Channel Arbiter 228. Also, in the DMA Engine 210 is a Hardware Handshake Interface 212 with Hardware Handshake lines 213, Configuration registers 214, and a User Interface 216 that communicates using Configuration Interface lines 217. Also shown in the DMA Controller 120 is a Multiport Master Interface 238 that is coupled to and communicates bidirectionally with the DMA Internal Channel Arbiter 228. The Multiport Master Interface 238 contains one or more Bus Master Interfaces 240, 241, which are coupled to and communicate bidirectionally with the DMA Internal Channel Arbiter 228. Each Bus Master Interface 240 or 241 is coupled to and communicates bidirectionally with a System Bus 250, 251.

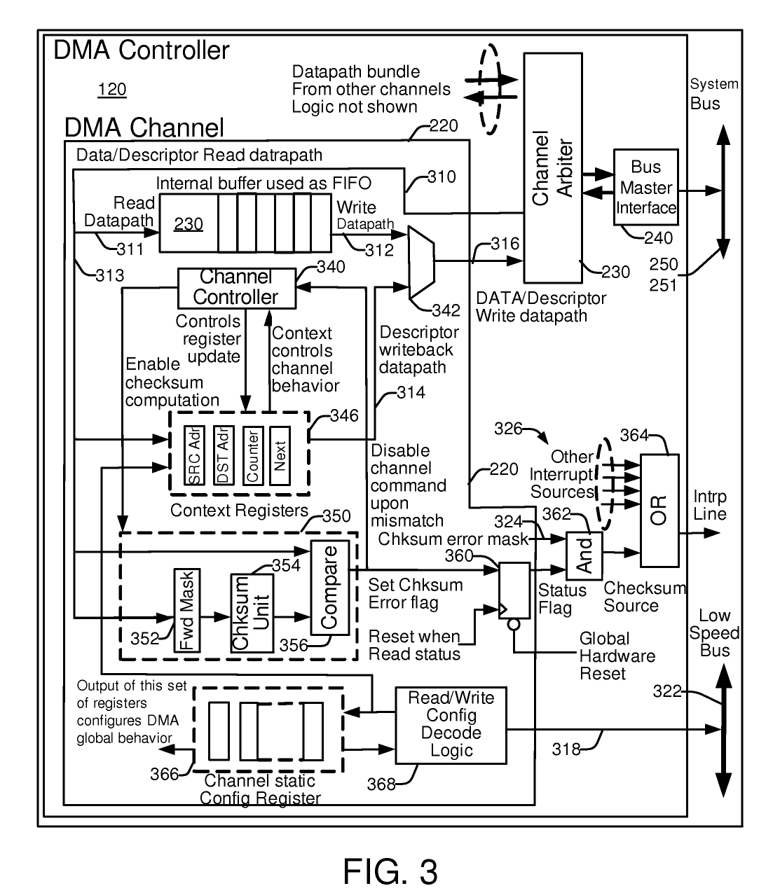

Each DMA channel 220, 221, 222, 223 can be divided into a set of context registers, a communications buffer 230, 231, 232, 233, and a channel controller (see FIG. 3). When enabled, a DMA channel 220, 221, 222, 223 gains access to the DMA internal bus interface, then gains access to the micro controller bus, reads data from a source address, and stores data at the destination address. If the access to the bus is not granted by the DMA internal channel arbiter 228, data may be temporary stored in the communications buffer 230, 231, 232, 233, (used as a FIFO). The communications buffer 230, 231, 232, 233, is a memory area allocated on a per channel 220, 221, 222, 223 basis or dedicated. The total amount of data read by the channel is defined in the buffer transfer size field (referred as BTSIZE field) of the TR_CTRL register. The TR_CTRL register is the Transfer Control register. That register belongs to the context registers set. The BTSIZE field is decremented when a data is successfully read. When this down counter reaches zero the DMA buffer transfer is terminated and the channel is automatically disabled. This description is characteristic when the data is read from the memory and written to the memory. The pace of the transfer is generally a function of the wait states inserted by the memory controller and the micro controller interconnection matrix. When dealing with peripherals, the pace of the transfer is generally also a function of the protocol. The hardware handshaking interface is normally used to improve the granularity of the transfer. As soon as a data transfer is requested by the peripheral, a defined amount of data is transferred, which may be programmable or modified on a per request basis. The DMA channel typically asserts its acknowledge line to inform the peripheral that the DMA has terminated its transfer. If the transfer size is not defined the peripheral uses a dedicated hardware line to terminate the DMA transfer. In that case, the BTSIZE is no longer programmed before the transfer start. This field is nevertheless used at the end of the transfer and indicates how many data have been transferred. In that case the initial value is internally set to 0 (zero) by the channel and incremented gradually as the transfer proceeds. The operating system would then perform a read register operation to report the quantity of read data. Even if the transfer is not known at runtime, a special mechanism may be integrated to guarantee an upper bound on the amount of data. Simple logic can avoid memory area overflow.

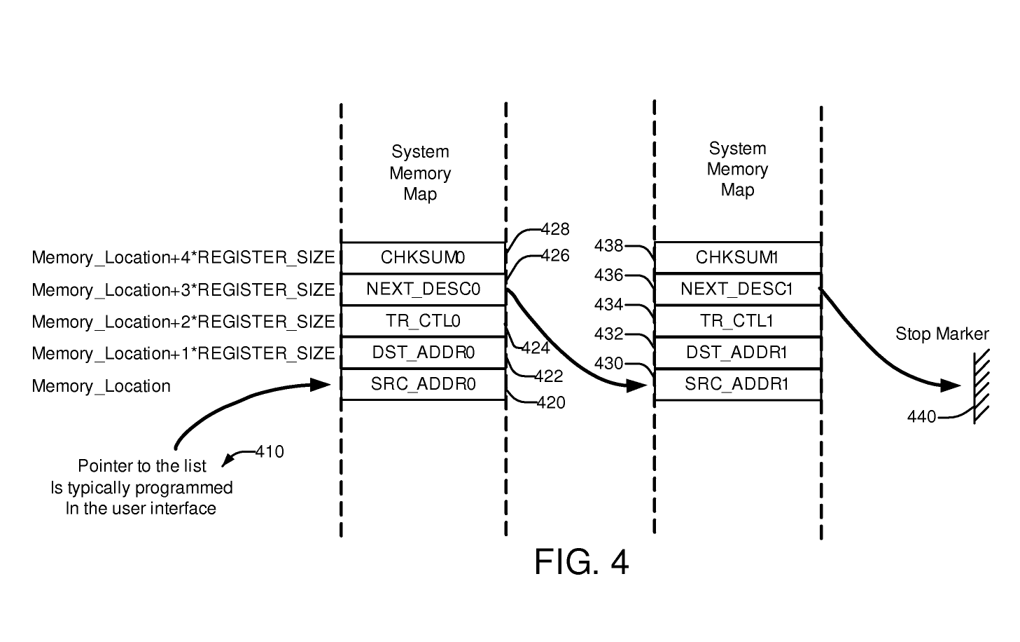

Generally, the assertion of the acknowledge signal does not always guarantee that the data is written into the memory or into the peripheral. The interconnection network can include a pipeline stage to increase the maximum operating frequency, and data maybe temporary buffered between the master and the slave. In order to avoid CPU overhead, a linked list traversing mechanism can be used to re-program the channel context when the transfer has terminated. Before the implementation of linked lists of descriptors, a DMA transfer was typically completed when the BTSIZE down counter reached zero. Then, CPU intervention was required. Using the linked list mechanism in accordance with embodiments of the invention (e.g., FIG. 4), CPU intervention is minimized. The processor is interrupted when the linked list “stop” marker (called the NULL pointer) is encountered while traversing the linked list. The linked list is a data structure consisting of a sequence of nodes, each containing arbitrary data fields, and one reference pointing to the next node (see FIG. 4). The data fields of each node in the linked list contain information of the channel context registers. This information is stored in the form of a channel descriptor. When mapped to channel context registers, a descriptor defines the current channel transfer properties. The channel executes a task that relies only on the accuracy of the channel descriptor. When enabled and correctly configured, the channel fetches the first descriptor pointed out by the base address for the linked list. The channel internal context registers are programmed automatically and execute the corresponding I/O functions. In some implementations, when a DMA transfer is complete, the channel can optionally perform a write back operation into the descriptor, wherein the DMA modifies the content of the descriptor in order to inform the operating system that the corresponding I/O operation is complete and the descriptor can now be freed or reused. The sequence of operation: “fetch descriptor, do DMA transfer and optional descriptor write back” is performed until the next descriptor address (NEXT_DESC) in the linked list points to the “stop” marker.

In many cases, descriptors are located in on-chip or off-chip memory, but descriptors may also reside in a memory mapped peripheral. In the latter case, the peripheral typically contains a hardware mechanism to generate the descriptor and cope with the hardware handshaking interface.

The DMA controller 120 normally has a direct connection with peripherals and memory, bypassing the memory management unit (MMU) and memory protection unit (MPU) 114. This is also typical for every others master peripherals that integrates a direct memory access controller. Operations performed by a DMA controller 120 occur because there is typically no means to prevent an illegal access. A configuration issue in the channel context register could potentially lead to a serious system hazard. It is normally desirable to verify the integrity of a descriptor prior to any execution, in order to guarantee system robustness. For example: when located in memory, descriptors integrity may be threatened by CMOS random failure. The CMOS scaling reliability issue is taken into account. Indeed scaling will generally bring more leakage; long-term quality/reliability is also impacted (i.e., through the hot electron effect). This can increase soft errors. When fetched in SDRAM, descriptors may be read corrupted.

FIG. 3 is a diagram showing a DMA channel 220 with embedded transfer descriptor integrity checked, in accordance with one embodiment of the present invention. For simplicity, only DMA channel 220 is described, but embodiments of DMA channel 220 may be used for DMA channels 221, 222, and 223. Coupled to and bidirectionally communicating with the System Bus 250, 251 is the Bus Master Interface 240, which, in turns, is coupled to and bidirectionally communicates with the Channel Arbiter 230. The Channel Arbiter 230 is coupled to and bidirectionally communicates with each of the DMA channels 220, 221, 222, 223.

Within the DMA channel 220, a Data/Descriptor Read datapath 310 is responsively coupled to and receives input data from the Channel Arbiter 230. The Data/Descriptor Read datapath 310 is coupled to and provides input data to internal buffers used as a FIFO 230 as a Read Data Datapath 311, context registers 346 as a Read Descriptor datapath 313, and a descriptor validation module 350. The internal buffers 230 are coupled to and provide data signals to a multiplexer 342 over a Write Data Datapath 312. Also coupled to and providing signals to the multiplexer 342 are the context registers 346 via a Descriptor Writeback datapath 314. The context registers 346 control channel 220 activity on a per transfer basis (channel static Configuration Registers discussed below provide global control of the channel). In this embodiment, four context registers are shown: SRC_ADDR (source address), DST_ADDR (destination address), Counter (within the TR_CTL register), and Next (NEXT_DESC). As will become evident below, these registers are loaded in this embodiment from the linked list of descriptors shown in FIG. 4. The context registers 346 are coupled to and bidirectionally communicate with a channel controller 340, which together control the actual channel I/O. The multiplexer 342 is responsively coupled to and receives descriptors from the context registers 346 over the Descriptor Writeback datapath 314. The Channel Arbiter 230 is then responsively coupled to and receives output data from the multiplexer 342 over a Data/Descriptor Write datapath 316. Thus, the Channel Arbiter 230 can selectively receive signals from the Data Write datapath 312 and the Descriptor Writeback datapath 314 for transmission to the Bus Master Interface 250 utilizing multiplexer 342.

The descriptor validation module 350 receives input signals from the Descriptor Read datapath consisting of descriptors being loaded into the context registers 346. There are two parallel threads in the descriptor validation module 350. In the first, the incoming descriptors are passed through a Forward Mask 352, and then a checksum is computed by Checksum Unit 354 from the masked value. This is compared to the checksum in the original descriptor 356 (second thread). The output signal from the comparator 356, if asserted, is latched or captured with a flip flop as a descriptor checksum error flag 360. Also, the output of the comparator 356 is coupled to and provides a signal to the channel controller 340 in order to disable channel commands on detection of a corrupted descriptor by the descriptor validation module 350. The descriptor checksum error flag 360 can be cleared via either a global hardware reset or when reading the next descriptor. The descriptor checksum error flag 360 provides one input to an AND gate 362, and the other input is provided by a Checksum error mask 324 in order to selectively enable and disable reporting of this error. The output of the AND gate 362 is ORed 364 with other interrupt sources 326 to assert a signal on an Interrupt Line 320 indicating that an interrupt has occurred.

Read/Write Configuration Decode Logic 368 is coupled to and bidirectionally communicates with a local bus 322 via line 318. This allows the operating system to set global channel configuration parameters. The Read/Write Configuration Decode Logic 368 is coupled to and bidirectionally communicates with Channel Static Configuration Registers 366 which hold the global configuration parameters for the channel. The global configuration parameters are provided to the context registers 346, which are in turn used to control the Channel Controller 340.

It should be understood that FIG. 3 shows one exemplary embodiment. However, other embodiments and configurations are within the scope of this invention.

FIG. 4 is a diagram showing an exemplary linked list of DMA descriptors, in accordance with one embodiment of the present invention. Implementation of transfer descriptors with integrity check capability as the data structure of the linked list typically desires that the low level software be correspondingly updated, which, in turns, desires that a checksum field (“CHKSUM”) be added to the descriptors and that such a checksum be computed by the operating system. This new field may be or may not be visible through the user interface. When a descriptor fetch operation is performed, the channel computes a checksum on the data fields of the descriptor on the fly. At the end of the fetch operation the computed checksum is compared with the checksum read from the device. In one embodiment, a simple parity check of the data fields can be performed. Other implementations are also within the scope of this invention, including the use of ECC.

In this FIG. 4, two descriptors are shown in this linked list of DMA descriptors. In this embodiment, each descriptor is five times the register size in size. Each descriptor has a source address (SRC_ADDRₙ), a destination address (DST_ADDRₙ), a transfer control set of bits (TR_CTLₙ), a link to the next descriptor in the linked list (NEXT_DESCₙ), and a Checksum or ECC (CHKSUMₙ). In this example, the head of the linked list is pointed to by a pointer that is typically programmed in the user interface 410. This contains the address of the first byte (word, etc.) of the first entry in the linked list. The first entry in the linked list contains SRC_ADDR₀ 420, DST_ADDR₀ 422, TR_CTL₀ 424, NEXT_DESC₀ 426, and CHKSUM₀ 428 entries. The NEXT_DESC₀ 426 entry points at the second descriptor in the linked list, which has SRC_ADDR₁ 430, DST_ADDR₁ 432, TR_CTL₁ 434, NEXT_DESC₁ 436, and CHKSUM₁ 438 entries. The NEXT_DESC₁ 436 entry contains a Stop Marker 440, indicating that this is the end of the linked list of descriptors.

It should be understood that the structure shown in the FIG. 4 is exemplary, and that other structures and organizations are also within the scope of the present invention. For example, a vector of descriptors may be utilized instead of a linked list. Also, the number, contents, and size of the fields in a descriptor may vary between architectures. Also, for example, if an ECC is utilized instead of a checksum, the size of an ECC field will typically be larger than for a checksum field.

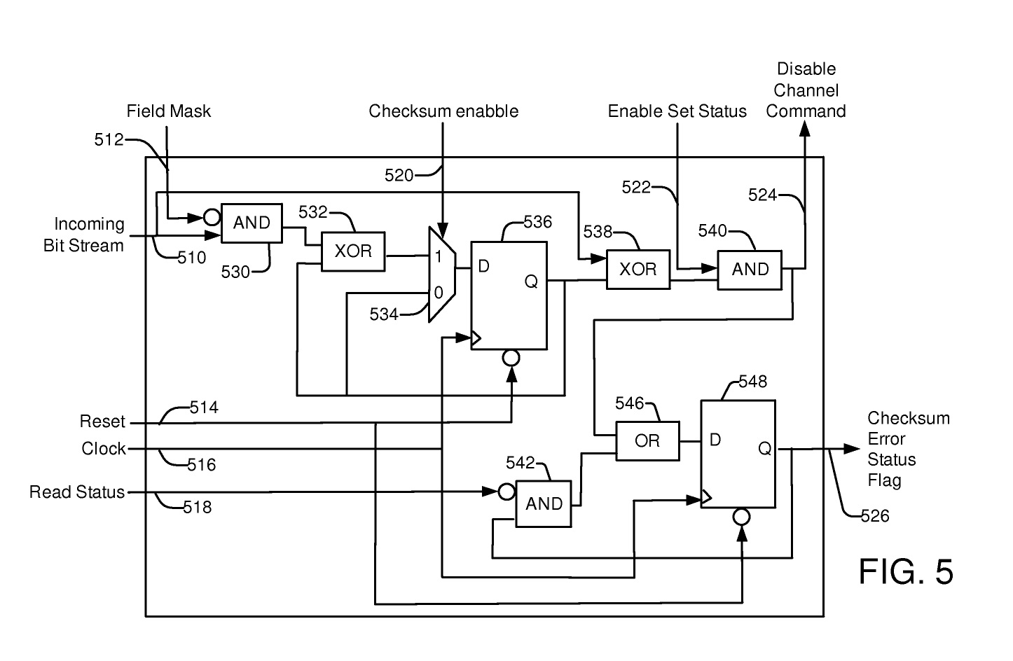

FIG. 5 is a diagram showing a simple sequential parity check circuit, in accordance with one embodiment of the present invention. It is one example of the descriptor validation module 350 shown in FIG. 3. The Sequential parity circuit present in this FIG. 5 verifies the parity of the incoming bit stream. It is slightly different than an “exclusive or” (XOR) on the context registers because, if not write protected, context registers may have been updated between the fetch stage and the “compare stage”.

A first AND gate 530 has two inputs, the Incoming Bit Stream 510 and a negated Field Mask 512. The output of the first AND gate 530 provides one input to a first XOR gate 532. The second input to the first XOR gate 532 is the “Q” (non-inverting) output of a first Data flip/flop (DFF) 536. The output of the first XOR gate 532 provides the “1” input to a 2×1 multiplexer 534. The “0” input to the multiplexer 534 is provided by the output from the first DFF 536. The select for the multiplexer 534 is provided by a Checksum Enable signal 520. The output from the multiplexer 534 provides the “D” (Data) input to the first DFF 536. A Clock signal 516 provides a clock or register signal to the first DFF 536 and a second DFF 548. Similarly, a Reset signal 514 provides a reset signal to the first DFF 536 and the second DFF 548. The Incoming Bit Stream signal 510 and the “Q” (non-inverting) output of the first DFF 536 provide two inputs to a second XOR gate 538. The output of the second XOR gate 538 and an Enable Set Status signal 522 provide two inputs to a second AND gate 540. The output of the second AND gate 540 provides a Disable Channel Command signal 524.

A Read Status signal 518 provides one negated input to a third AND gate 542. The “Q” (non-inverting) output from the second DFF 548 provides a second input to the third AND gate 542. The output of the third AND gate 542 provides one input to an OR gate 546 and a second input is provided by the output of the second AND gate 540. The output from the OR gate 546 provides the “D” input to the second DFF 548. The “Q” (non-inverting) output from the second DFF 548 provides a Checksum Error Status Flag 526.

Instead of using a checksum, an error correcting code (ECC) could be used. If the error can be recovered automatically, the CPU is not interrupted, and the DMA transfer proceeds. If the error correcting capability of the code has been exceeded, the CPU will typically be interrupted to handle the exception.

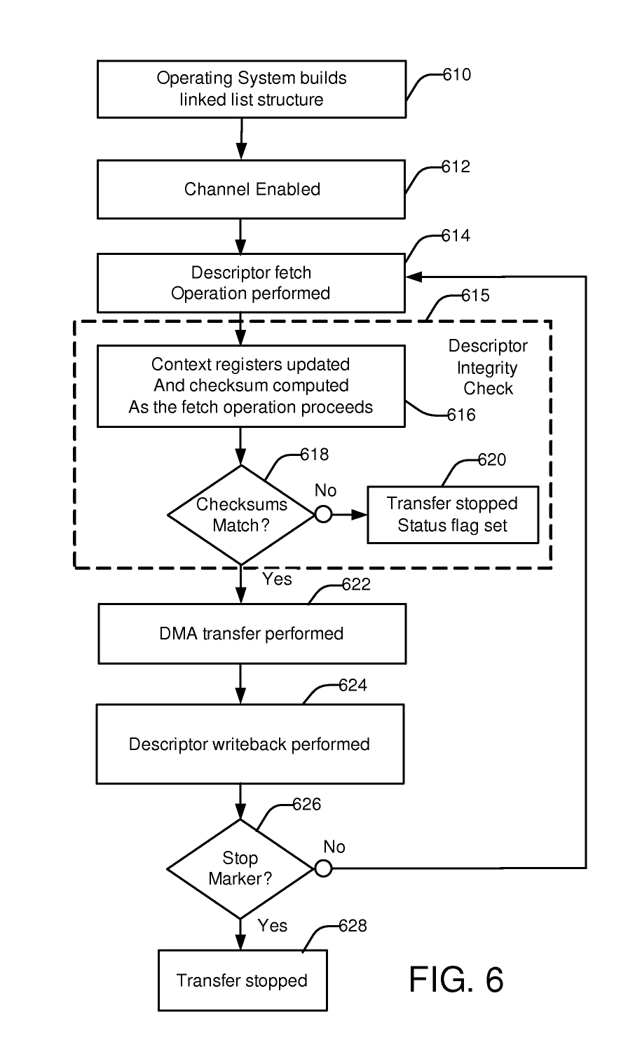

FIG. 6 is a Channel descriptor fetch flowchart, in accordance with one embodiment of the present invention. As the DMA controller could optionally perform a descriptor write back operation, a subset of fields may be modified. These fields could be excluded from the checksum computation using a mask mechanism. When a 32 bit or 64 bit data is fetched, a mask is applied and the checksum is computed on the masked data, and therefore only a subset of bits is taken into account. As the modified fields are excluded from the checksum computation, the descriptor can be reused. This simple mask option can simplify use of a circular linked list. Indeed, when modified by the DMA controller, one descriptor may generally not be used, because the DMA Controller would not have updated the checksum at the same time. A checksum mismatch would typically appear. Fields that could be excluded from the checksum include DONE and BTSIZE fields located in the TR_CTRL register. The DONE field is, by definition, modified in the descriptor when the DMA transfer has completed the descriptor task. The BTSIZE field may be updated when the peripheral is defined as the flow controller. In that later case, the BTSIZE is not known when the channel is enabled. The Peripheral would assert a hardware line to inform the DMA controller that the current transfer is over. Eventually, when the descriptor write back phase is entered, the BTSIZE field located in memory is also updated. This operation generally informs the operating system of the total amount of transferred data. When a checksum mismatch occurs, the descriptor is corrupted and a status flag is raised. If not masked an interrupt is raised and the CPU calls the ISR (interrupt service routine) to handle that exception. As the descriptor has been loaded but not executed the CPU can check which field is faulty.

In this FIG. 6, the Operating System builds a linked list structure of DMA descriptors (see FIG. 4), step 610. The channel is then enabled, with the current link pointing at the first DMA descriptor in the linked list, step 612. A descriptor fetch operation is performed in order to fetch the next descriptor in the linked list, step 614. The method then enters a Descriptor Integrity Check section 615. Context registers are updated and a checksum (ECC, etc.) is computed as the fetch operation proceeds, step 616. A check is then made to determine whether the computed checksum matches the checksum in the current descriptor, step 618. If the checksums do not match, and an ECC was provided (instead of a checksum), ECC correction is attempted. If the checksums do not match, or ECC correction fails, the transfer is stopped (typically, by disabling the DMA channel 220) and a status flag is set (descriptor checksum error flag 360), step 620. This ends the Descriptor Integrity Check section 615.

If the checksums match, or ECC correction succeeds, step 618, the DMA transfer is performed, step 622. The updated descriptor is then optionally written back, step 624. The link to the next descriptor in the linked list is checked, and if it is a stop marker, step 626, the transfer is stopped and marked successful, step 628. Otherwise, if the next descriptor is not a Stop Marker, step 626, it is fetched, step 614, and the loop repeated starting at the Descriptor Integrity Check 615.

Those skilled in the art will recognize that modifications and variations can be made without departing from the spirit of the invention. Therefore, it is intended that this invention encompass all such variations and modifications as fall within the scope of the appended claims.

What is claimed is:

1. A controller for providing direct memory access to peripherals comprising:
a direct memory access channel comprising:
a means for fetching a descriptor as a current descriptor, wherein the descriptor contains a set of register values and an integrity check value;
a means for loading a set of context registers from the current descriptor;
a means of controlling an operation of the direct memory access channel through utilizing the set of context registers in order to perform an I/O function on the direct memory access channel; and
a means for integrity checking a predetermined subset of the set of register values in the current descriptor utilizing the integrity check value.

2. The controller in claim 1 wherein:
the integrity check value is a checksum; and
the means for integrity checking comprises:
a means for computing a checksum on the predetermined subset of the set of register values in the current descriptor as a computed checksum;
a means for comparing the checksum in the current descriptor with the computed checksum;
a means for reporting a mismatch between the checksum in the current descriptor and the computed checksum.

3. The controller in claim 1 wherein:
the integrity check value is an error correcting code; and
the means for integrity checking comprises:
a means for testing the error correcting code against the predetermined subset of the set of register values in order to determine whether the predetermined set of register values in the current descriptor is corrupted;
a means for correcting a single bit error in the predetermined subset of the subset of registers;
a means of reporting that the predetermined subset of the set of register values is corrupted and cannot be corrected.

4. The controller in claim 1 wherein:
the predetermined subset of the set of register values comprises an entire set of the register values from the current descriptor.

5. The controller in claim 1 wherein:
the current descriptor is a one of a set of descriptors linked together in a linked list;
the channel further comprises:
a means for testing whether a link to a next descriptor in the current descriptor is a stop link upon successful completion of an I/O transfer on the direct memory access channel;
a means for fetching the next descriptor from the linked list as the current descriptor when the link to the next descriptor is not the stop link; and
a means of repeating operation of the means for loading, means for controlling, and means for integrity checking until at least one of a set comprising: a corrupted descriptor is detected and the next link in the current descriptor is the stop link.

6. The controller in claim 1 further comprising:
a means for disabling an operation of the direct memory access channel when the means for integrity checking detects a corrupted descriptor.

7. The controller in claim 1 further comprising:
a means for asserting an interrupt when the means for integrity checking detects a corrupted descriptor.

8. The controller in claim 1 further comprising:
a means for setting a flag when the means for integrity checking detects a corrupted descriptor; and
a means for clearing the flag.

9. An electronic system comprising:
a system bus;
a processor coupled to the system bus;
a memory coupled to the system bus; and
a controller coupled to the system bus comprising a direct memory access channel comprising:
a means for fetching a descriptor as a current descriptor, wherein the descriptor contains a set of register values and an integrity check value;
a means for loading a set of context registers from the current descriptor;
a means for controlling an operation of the direct memory access channel through utilizing the set of context registers in order to perform an I/O function on the direct memory access channel; and
a means for integrity checking a predetermined subset of the set of register values in the current descriptor utilizing the integrity check value.

10. The electronic system in claim 9 wherein:
the integrity check value is a checksum; and
the means for integrity checking comprises:
a means for computing a checksum on the predetermined subset of the set of register values in the current descriptor as a computed checksum;
a means for comparing the checksum in the current descriptor with the computed checksum;
a means for reporting a mismatch between the checksum in the current descriptor and the computed checksum.

11. A method of operating a direct memory access channel comprising:
fetching a descriptor containing a set of register values and an integrity check value as a current descriptor;
loading the set of register values from the current descriptor into a set of context registers;
integrity checking the set of register values from the current descriptor; and
performing a direct memory access transfer controlled by the set of context registers.

12. The method in claim 11 further comprising:
enabling the direct memory access channel before fetching the current descriptor.

13. The method in claim 11 further comprising:
writing back a modified version of the descriptor.

14. The method in claim 11 wherein:
the current descriptor is a current one of a set of descriptors organized in a linked list;
the method further comprises:
testing a next link in the current descriptor for a next descriptor;
fetching the next descriptor to be used as the current descriptor if the next link is not a stop marker and then repeating the loading, integrity checking, performing as a loop, and testing until at least one of a set comprising:
the next link is the stop marker and the integrity checking detects a corrupted descriptor.

15. The method in claim 14 further comprising:
disabling the direct memory access channel when the loop terminates.

16. The method in claim 11 wherein:
the integrity check value is a checksum; and
the integrity checking comprises:
computing a checksum on a subset of the register values as a computed checksum; and
comparing the computed checksum to the checksum in the current descriptor.

17. The method in claim 11 wherein:
the integrity check value is an error correcting code; and
the integrity checking comprises:
determining whether a selected subset of the register values in the current descriptor is corrupted utilizing the error correcting code;
correcting the selected subset of the register values if corrupted and error correcting is possible utilizing the error correcting code; and
identifying the current descriptor as corrupted if unable to correct it utilizing the error correcting code.

18. The method in claim 11 further comprising:
terminating transfers on the direct memory access channel if the integrity checking detects that the selected subset of register values in the current descriptor is corrupted.

19. The method in claim 11 further comprising:
setting a flag if the integrity checking detects that the selected subset of register values in the current descriptor is corrupted.

20. The method in claim 11 further comprising:
raising an interrupt if the integrity checking detects that the selected subset of register values in the current descriptor is corrupted.
